(19) United States
(12) Patent Application Publication
(10) Pub. No.: US 2008/0003872 A1
(43) Pub. Date: Jan. 3, 2008

(54) Coupling

(75) Inventors: Qi Chen, Maulburg (DE); Klaus Feisst, Stegen (DE); Eric Bergmann, Steinen (DE)

Correspondence Address: BACON & THOMAS, PLLC, 625 SLATERS LANE, FOURTH FLOOR, ALEXANDRIA, VA, 22314, US

(73) Assignee: Endress + Hauser GmbH + Co. KG, Maulburg (DE)

(21) Appl. No.: 10/583,507

(22) PCT Filed: Dec. 14, 2004
(86) PCT No.: PCT/EP04/53461

§ 371 Date: Jun. 27, 2007

(30) Foreign Application Priority Data
Dec. 18, 2003 (DE) 10359867.7

(51) Int. Cl. H01R 9/05

(52) U.S. Cl. 439/578

(57) ABSTRACT

For optimizing couplings used until now, an arrangement is provided for a coupling of electromagnetic signals from a coaxial cable into a hollow conductor, in which an exciter pin is continued in the hollow conductor from a rear wall of the hollow conductor and is electrically conductively connected with a side wall of the hollow conductor.

The invention relates to a coupling, and especially to a coupling involving a transition from a coaxial line into an air, or dielectric, filled, hollow conductor.

Such couplings are known and are used, for example, in devices in which a high frequency, electromagnetic signal produced in a suitable electronic circuit is passed via a coaxial cable from the electronic circuit to a hollow conductor, or waveguide. Frequently, for this purpose, a plug-in connection is provided, in, or on, the hollow conductor. An inner conductor of the coaxial cable is continued inside the hollow conductor as exciter pin. As known from the theory of propagation of electromagnetic waves and especially for hollow conductors, the TEM mode existing in the coaxial cable is converted into the fundamental mode TE11 of the hollow conductor.

Couplings, or arrangements, of this kind for the coupling of electromagnetic signals from a coaxial line into a hollow conductor are used in devices for the sending and receiving of electromagnetic signals, such as, for example, in radio installations, in distance measuring devices which work on the basis of the travel-time method, and, especially, in fill level measuring devices using the travel-time principle for industrial measurements technology.

In the case of conventional couplings, coupling is from the side into the hollow conductor, with the inner conductor of the coaxial line serving, in the form of a pin- or mushroom-shaped exciter, to excite the TE11 mode in the hollow conductor. This lateral coupling requires an outer plug connection and, therefore, however, involves a high requirement for space. It is also unfavorable as regards assembly. The lateral coupling is also unsuited for direct coupling without HF-cable.

Another coupling is known, in the case of which the inner conductor of the coaxial cable extends “from behind” through a rear wall of the hollow conductor, into the hollow conductor, and continues further in its interior in the form of a wire loop. A tip of the wire loop is electrically connected with the rear wall of the hollow conductor. This coupling is, because of its difficult HF-matching and its low robustness, unfavorable in fabrication. For many applications, it is unsuited, since it is narrow-banded.

U.S. Pat. No. 3,737,812 described yet another coupling “from behind” into the hollow conductor. In the case of this coupling, the inner conductor of the coaxial cable widens in a step-shaped geometry extending into the hollow conductor and electrically contacts a side wall in the interior of the hollow conductor. The fabrication of this coupling is very complex and expensive, and its HF-matching is not simple.

An object of the invention, therefore, is to provide an arrangement for coupling, which avoids the above-described disadvantages, is especially space-saving, simple and robust to fabricate, and permits a simple HF-matching and is suited for broadband applications.

This object is achieved according to the invention by an arrangement for a coupling of electromagnetic signals from a coaxial line into a hollow conductor, wherein an inner conductor of the coaxial cable enters a rear wall of the hollow conductor, the inner conductor is continued in the hollow conductor in the form of an exciter pin, and a tip of the exciter pin away from the rear wall of the hollow conductor is connected electrically conductively with a sidewall of the hollow conductor.

In a special form of embodiment of the arrangement of the invention, the hollow conductor has a cylindrical bore.

In a further form of embodiment of the arrangement of the invention, a hollow conductor with a conical bore is provided.

In yet another form of embodiment of the arrangement of the invention, the inner conductor of the coaxial cable enters eccentrically into the rear wall of the hollow conductor.

Still other forms of embodiment of the arrangement of the invention provide that the bore of the hollow conductor is filled with a dielectric material, preferably a perfluoro plastic.

A special advantage of the invention is that it is not only space-saving, but also saves material thereby. It enables a good and, above all, a broadband HF-matching, as well as a simple and cost-favorable manufacture. By the electrical contact of the exciter pin with a wall of the hollow conductor, static charge buildup on the exciter pin is prevented.

The invention will now be explained and described in greater detail on the basis of examples of embodiments, wherein reference is made to the appended drawing, the figures of which show as follows:

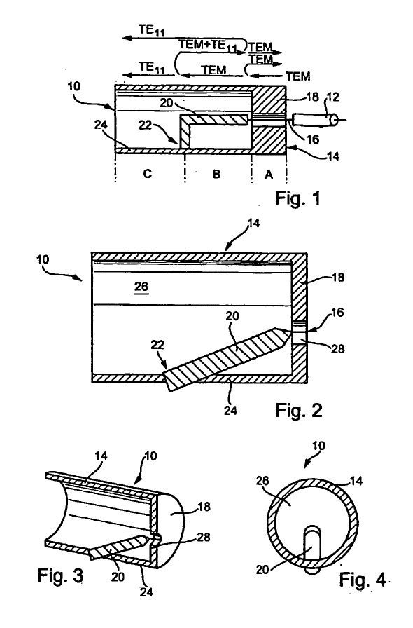

FIG. 1 a schematic drawing of a coupling of a coaxial cable into a hollow conductor;

FIG. 2 in section, an example of an embodiment of an arrangement for coupling according to the invention;

FIG. 3 the arrangement of FIG. 2 in a perspective drawing of a sectioned hollow conductor at a scale reduced compared to FIG. 2; and

FIG. 4 the arrangement of FIG. 3 in perspective, in the form of a view from in front, into the hollow conductor.

For simplification, equal components, modules and devices are given equal reference characters in the drawing.

The schematic drawing of FIG. 1 serves for general explanation of the arrangement 10 of the processes in the case of a coupling of high frequency, electromagnetic signals from a coaxial cable 12 into a hollow conductor 14, for example a round, hollow conductor. An inner conductor 16 of the coaxial cable 12 enters a rear wall 18 of the hollow conductor 14. The inner conductor 16 is continued in the hollow conductor 14 as an exciter pin 20, and an exciter pin tip 22 away from the rear wall 18 of the hollow conductor is connected electrically conductively with a sidewall 24 of the hollow conductor 14. As is known, of concern here is the converting of the TEM-wave in the coaxial cable 12 into a TE11 wave. To this end, the hollow conductor 14 is to be dimensioned such that no higher modes can be propagated except TEM and TE11, since they represent the lowest existing solutions of the Maxwell-equation. The disturbed rotational symmetry of the field distribution of the TEM-waves leads to an asymmetric field distribution of TE11-waves. Reflections at disturbances must be destructively interfered. These processes are illustrated by the flow diagram in the upper part of FIG. 1. The arrangement 10 has, for purposes of discussion, been divided into three sections A, B, C, with section A representing a region where the TEM-waves can propagate, section B a region where both TEM and TE11 waves can propagate, and section C a region where TE11-waves can propagate.

In order to achieve good coupling properties, the geometry of the arrangement 10 must be so optimized that the two reflected TEM-waves (see the diagram in the upper part of FIG. 1) destructively interfere, thus the case of a phase shift of, and the transmitted TE11-waves constructively interfere, thus the case of a phase shift of 2. With an abrupt transition of the exciter pin 20 at the sidewall 24 of the hollow conductor 14, however, as in the case of the example illustrated in FIG. 1, only a relative small bandwidth can be achieved. The invention solves this problem by making the transition of the exciter pin 20 onto the sidewall 24 softer than displayed in FIG. 1.

FIG. 2 shows an arrangement 10 of the invention made in this way, wherein the drawing of the coaxial cable (see FIG. 1) has been omitted. The inner conductor 16 of the coaxial cable is expediently situated in a glass feedthrough 28 in the rear wall 18 of the hollow conductor. Hollow conductor 14, for example a round, hollow conductor, is preferably filled with a dielectric material, preferably with a material formed of perfluoro-plastic, for example a polytetrafluoroethylene or perfluoroalkoxy-copolymer. The exciter pin 20 is embodied as a straight pin and extends in the hollow conductor at an angle inclined with respect to the sidewall 24. In the region, where the exciter pin electrically contacts the sidewall 24 of the hollow conductor 14, an appropriate groove is milled into the cylinder 26 of dielectric material filling the hollow conductor 14, so that, in the case of an already emplaced exciter pin 20, the cylinder 26 can be pushed into the hollow conductor 14. Expediently, the contacting of the exciter pin 20 is given extra attention, since it must be executed very carefully. Both at the contact of the exciter pin 20 with the conductor 16 of the glass feedthrough 28 and at the contact of the exciter pin 20 with the sidewall 24 of the hollow conductor 14, a high electrical current flows on the surface.

FIGS. 3 and 4 show the arrangement 10 of the invention of FIG. 2 in perspective representations. Visible are the hollow conductor 14, its rear wall 18, the exciter pin 20 and the glass feedthrough 28. For FIG. 3, a sectional drawing was selected, wherein the cylinder 26 (see FIG. 2) of dielectric material is not shown in this instance. FIG. 4 shows the arrangement 10 in a view from the front, thus into the interior of the hollow conductor 14.

All three FIGS. 2, 3 and 4 show clearly that the glass feedthrough 28 for the inner conductor 16 of the coaxial cable is arranged eccentrically in the rear wall 18 of the hollow conductor 14. Accordingly, the exciter pin 20 also sits eccentrically on the rear wall 18 in the interior of the hollow conductor 14.

Instead of the round, hollow conductor of cylindrical bore shown here, by way of example, for a special form of embodiment of the invention, also hollow conductors of conical bore can be used.

Tests have shown, that the arrangement of the invention for coupling is very well suited for use with fill level measuring devices of industrial measurements technology for determining fill level of a medium in a container or tank by means of high frequency, electromagnetic, measurement signals, which are transmitted to the medium and reflected on such, and then evaluated according to the travel-time principle.

### LIST OF REFERENCE CHARACTERS

10 arrangement for coupling
12 coaxial cable
14 hollow conductor
16 inner conductor
18 rear wall
20 exciter pin
22 tip of the exciter pin
24 sidewall of hollow conductor
A,B,C sections

1-6. (canceled)

7. An arrangement for a coupling of electromagnetic signals from a coaxial cable, the arrangement including a hollow conductor having a side wall and a rear wall, and the coaxial cable having an inner conductor, wherein:
said inner conductor of the coaxial cable enters in said rear wall of said hollow conductor;
said inner conductor is continued in said hollow conductor as an exciter pin; and a tip of said exciter pin away from said rear wall of said hollow conductor is electrically conductively connected with said sidewall of said hollow conductor.

8. The arrangement as claimed in claim 7, wherein:
said hollow conductor further includes a cylindrical bore.

9. The arrangement as claimed in claim 7, wherein:
said hollow conductor further includes a conical bore.

10. The arrangement as claimed in claim 7, wherein:
said inner conductor of said coaxial cable enters eccentrically in said rear wall of said hollow conductor.

11. The arrangement as claimed in claim 8, wherein:
said bore of said hollow conductor is filled with a dielectric material.

12. The arrangement as claimed in claim 11, wherein:
said dielectric material is a perfluoro plastic.

13. The arrangement as claimed in claim 8, wherein:
said inner conductor of said coaxial cable enters eccentrically in said rear wall of said hollow conductor.

14. The arrangement as claimed in claim 9, wherein:
said inner conductor of said coaxial cable enters eccentrically in said rear wall of said hollow conductor.

15. The arrangement as claimed in claim 9, wherein:
said bore of said hollow conductor is filled with a dielectric material.

16. The arrangement as claimed in claim 10, wherein:
said bore of said hollow conductor is filled with a dielectric material.
